(19) United States
(12) Patent Application Publication
(10) Pub. No.: US 2014/0141397 A1
(43) Pub. Date: May 22, 2014

(54) Method And Apparatus For Verified Education Of Patient Medical Conditions And Procedures

(71) Applicant: Meaghan Casey Dunn, Newtown, PA (US)

(72) Inventor: Meaghan Casey Dunn, Newtown, PA (US)

(21) Appl. No.: 13/680,854

(22) Filed: Nov. 19, 2012

(51) Int. Cl. G09B 5/02

(52) U.S. Cl. CPC G09B 5/02
USPC 434/262

(57) ABSTRACT

A computer-based apparatus for verified education of patient medical conditions and procedures provides 3D animations and 3D image stills, follow up quiz for patients, a built in informed consent form, usage tracking that gives a healthcare provider a consistent way to educated patients about anatomy, surgical and non-surgical procedures and medical conditions with the ability to track all usage records and a built in legal informed consent. Each view per patient is tracked and it is logged which healthcare provider was there, the 3D animations and/or 3D image stills viewed, a quiz was taken and scored, a digital informed consent form was signed and accompanied by screen grabs of the 3D animations and/or 3D image stills shared with the patient.

### CROSS REFERENCE TO RELATED APPLICATION

This application claims the benefit of U.S. Provisional Patent Application No. 60/561,123, filed Nov. 17, 2011, the entirety of which is hereby incorporated by reference into this application.

### BACKGROUND OF THE INVENTION

1. Field of the Invention

The present invention relates to an apparatus used for medical purposes and in particular to a computer-based apparatus for verified education of patient medical conditions and procedures.

2. Description of Related Art

It is desirable for a physician to obtain an informed consent that the patient has been informed of the benefits and risks of the medical procedure and consents to the procedure. However, patients have a difficult timing grasping an actual medical procedure or condition that a doctor explains to them. Conventional systems have been described to obtain informed consent from a patient after providing information to the patient through a network interface, requesting input from the patient and testing the patient to determine if they have achieved a predetermined level of understanding.

U.S. Patent Application Publication No. 2002/0062228 discloses an automated informed consent system which uses a computer to inform a patient about a proposed medical procedure and to verify that the patient understands the material presented. The system provides an audiovisual presentation using animation and/or voice-over to aid in the patient's understanding of the procedure and associated risks. The system comprises a patient interface connected to a network in which the patient interface includes at least one input device for use by the patient to provide input to the interface and a screen for displaying information to the patient. A server connected to the network in operative communication with the patient interface is also included. The server comprises a program stored in memory and accessible by the patient interface. Once a connection between the patient interface and server has been established, the interface is operable under control of the program to present information concerning a medical procedure to the patient via the screen. The patient interface also requests input from the patient via the input device, and determines from the input whether the patient has achieved a predetermined level of understanding of the information presented. The interface is further operable under the control of the program to generate a consent form for the medical procedure for review by a physician and execution by the patient.

It is desirable to provide an apparatus to be used by a healthcare provider to better educate a patient by allowing a healthcare provider to review with the patient play-listed animations of a medical condition or procedure and draw on the animation and/or still image of the medical condition or procedure and interactive 3D animation to further clarify a point to the patient. It is also desirable to verify education of the patient by tracking each view of the 3D and/or still images animation viewed by the patient, logging information identifying the healthcare provider present during review of the 3D animations and the 3D animations and/or still images viewed by the patient, providing and scoring a quiz taken by the patient and to provide a digital informed consent form that is executed by the patient and accompanied by screen grabs of the animations and/or still images shared with the patient as legal proof that will stand up in court. It is also desirable for the patient to later view online a repeat of what the healthcare provider had already shown to the patient.

### SUMMARY OF THE INVENTION

Patients have a difficult timing grasping an actual medical procedure or condition that a doctor explains to them. The present invention solves this problem.

The apparatus provides a play-list of 3D animations and/or 3D image stills for a medical procedure or medical condition. The apparatus can be used by healthcare providers to educate patients about various medical topics through animation including anatomy, medical conditions, diagnosis, procedure options, post procedural possibilities, risks, therapy options, medical options. The 3D animations can be provided with simplified and easy to understand voiceover in multiple languages and close captioning options to allow the patient to understand the medical procedure or medical condition. The patient can take a follow-up quiz to assure to the healthcare provider that the patient understands the medical condition or medical procedure viewed from the 3D animations and 3D image stills. The apparatus can provide a generated informed consent form to be executed by that patient after it is verified that the patient understands the patient procedures or medical conditions that is all tracked by date and time and still image screen captures.

A computer program provides detailed and realistic 3D animations with easy to understand script and voiceover in multiple language options or close captioning, with built in usage tracking that logs the time and date of views per patient id number, follow up quiz and scoring to assure the patient understands what was explained to them, then signs the built in informed consent form with accompanying screen shots of each animation viewed to digitally sign along with each medical staff employee also present. The 3D animation screens can be touch screens and the healthcare provider can manipulate the 3D animations of the anatomy, rotate, zoom in, zoom out, and draw on the animations (which pauses the animation) and still images of the library.

Optionally, a website can be included where patients can log in and view the 3D animation after the appointment with the healthcare provider to view again, or share with loved one(s) that is also tracked.

The invention will be more fully described by reference to the following drawings.

### BRIEF DESCRIPTION OF THE DRAWINGS

FIG. 1 is a schematic diagram of an apparatus for verified education of patient medical conditions and procedures.

FIG. 2 is a flow diagram of a method for verified education of patient medical conditions and procedures.

FIGS. 3A-3D are exemplary interfaces for a user of a logon screen for the apparatus of the present invention.

FIG. 4 is an exemplary interface for a user to access the apparatus of the present invention.

FIG. 5A is an exemplary interface for a user to review and create a play list of 3D animations and image stills.

FIG. 5B is an exemplary interface for a user to view 3D animations and image stills.

FIG. 6 is an exemplary interface for a user including a 3D image still.

FIG. 7 is an exemplary interface for a user to use a whiteboard.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

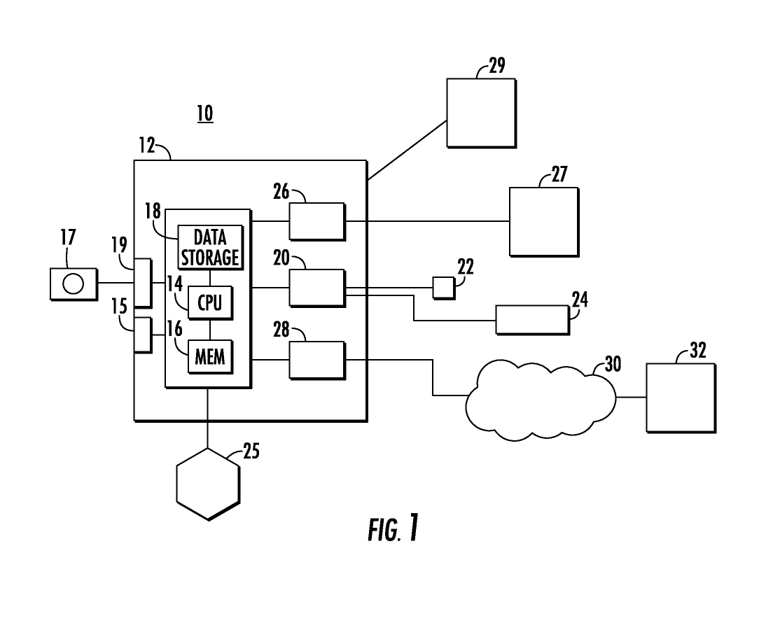

FIG. 1 is a schematic diagram of an apparatus for verified education of patient medical conditions and medical procedures 10. Healthcare provider 11 can execute commands perform functions or operations via a user interface, such as a graphical user interface (GUI), on personal computer (PC) 12. Personal computer (PC) 12 can be any type of well-known computer comprising a central processing unit (CPU) 14, memory 16 and data storage device 18, such as a hard drive. Computer program 15 can be stored on a CD-ROM or other non-volatile storage memory 17. Personal computer (PC) 12 can include a CD-ROM drive 19 that is used to access computer program 15 and store computer program 15 in memory 16. Personal computer (PC) 12 further comprises user input/output interface 20, which interfaces personal computer (PC) 12 to user input/output devices, such as mouse 22 and keyboard 24; video display interface 26, which interfaces personal computer (PC) 12 with video display 27, for example, a computer monitor; and communications network interface 28. Video display 27 can include for example a visual screen, display, touch screen, voice command and recognition.

Communications network interface 28, for example, interfaces personal computer (PC) 12 with cloud network 30, thereby providing communication with website application program 32. Alternatively, computer program 15 can be downloaded over communications network interface 28 and stored in memory 16.

Central processing unit (CPU) 14 can include microprocessor, microcontroller, programmable digital signal processor or other programmable device. A processor can also include an application specific integrated circuit, a programmable gate array programmable array logic, a programmable logic device, a digital signal processor, an analog-to-digital converter, a digital-to-analog converter, or any other device that may be configured to process electronic signals. In addition, a processor may include discrete circuitry such as passive or active analog components, including resistors, capacitors, inductors, transistors, operational amplifiers, and so forth, as well as discrete digital components such as logic components, shift registers, latches, or any other separately packaged chip or other component for realizing a digital function. Any combination of the above circuits and components, whether packaged discretely, as a chip, as a chipset, or as a die, may be suitable adapted to use as a processor as described herein. Where a processor includes a programmable device such as the microprocessor or microcontroller mentioned above, the processor may further include computer executable code that controls operation of the programmable device.

Memory 16 can include read-only memory, programmable read-only memory, electronically erasable programmable read-only memory, random access memory, dynamic random access memory, double data rate random access memory, Rambus direct random access memory, flash memory, or any other volatile or non-volatile memory.

Memory 16 can include code of computer program 15, stored program instructions, program data, and program output or other intermediate or final results. Memory 16 can also contain stored data, such as 3D animations and 3D image stills of anatomy having medical conditions or shown during medical procedures.

Computer program 15 is suitable for collecting or generating data of 3D animations and 3D image stills with easy to understand script and voiceover in multiple language options or close captioning, with built in usage tracking that logs the time and date of views per patient id number, generating a follow up quiz and scoring the quiz to assure the patient understands what was explained to them, generating an informed consent form, accepting a signature on the informed consent form, providing a record of the informed consent form with accompanying screen shots of each 3D animation and/or image stills viewed by the patient which is digitally signed by the patient along with the healthcare provider present during the process, facilitating data exchange, and allowing wired and/or wireless transmission of data.

Website application program 32 is an optional extension in which patients can login and view the exact same 3D animation(s) and/or 3D still image(s) with usage tracking which were previously viewed.

Computer program 15 houses the 3D animation and 3D image stills. Computer program 15 allows a user to draw on top of the 3D animation and 3D image stills, manipulate, move, rotate and zoom the 3D image stills simply by touching video display 26. PHP/HTML can be used to program website application program 32. 3D studio max, After Effects and Photoshop software can be used to create the 3D animation and 3D image stills. Computer program 15 can alternatively log all information into database 25. Database 25 can be stored on personal computer (PC) 12 or database 25 can be remote of personal computer (PC) 12. Information logged into database 25 can include user information, patient information, date, time, video version, language, questions, and answers, playlists created, profile edits to user or patients, drawings created on video, drawings on stills, drawings on the whiteboard, image stills imported, drawings on 3D interactive models, models viewed and interacted with, informed consent forms, viewed, and signed.

Computer program 15 can be written in QT programming language and then an executable file is generated. The 3D animation can be created with 3D studio max and then rendered out with after effects to output video files. 3D image stills can be created and exported as an .OBJ file for compatibility with QT programming language and various stages are created with highlights in Photo shop as png files to populate the still library of the software.

QT programming can be used to create a platform of computer program 15. 3D studio max and aftereffects can be used to create 3D animations and image stills to populate a player-list or library. Voiceover audio files can be added to accompany the 3D animations in various language options. Close captioning files can be added to the 3D animations as an option for ease of use for some patients. A draw feature on top of 3D animation and on 3D image stills in computer program 15 can be used as a tool for the healthcare provider to further clarify a point to better explain to a patient.

Computer program 15 can include information directed to medical specialty topics, such as, for example, cardiology, orthopedics, internal medicine, obstetrics, urology, oncology, pediatric, emergency care, and the like. It will be appreciated that any medical topic can be included in apparatus 10.

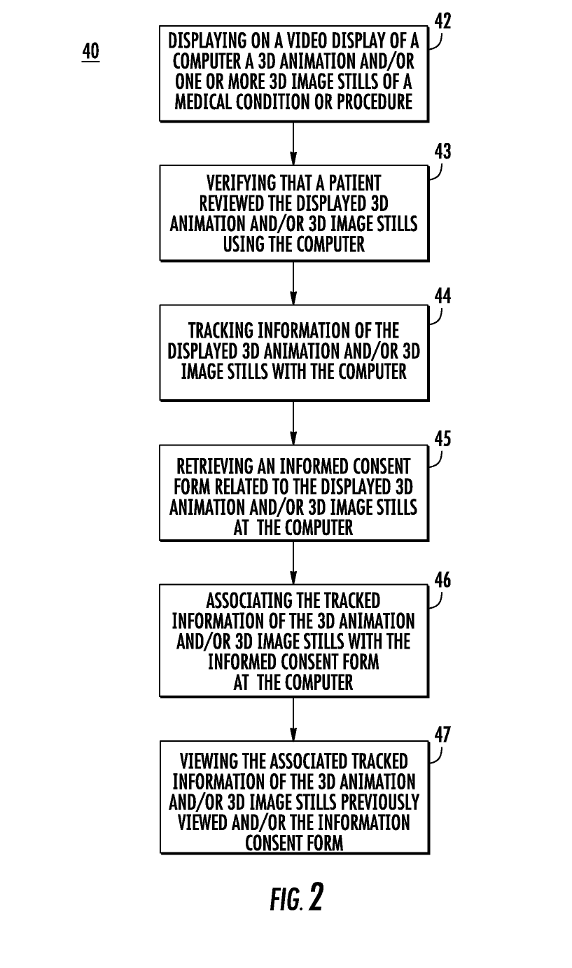

FIG. 2 is a flow diagram of a method for verified education of patient medical conditions and procedures. Displaying on a video display of a computer a 3D animation and/or one or more 3D image stills of a medical condition or procedure is performed in block 42. Verifying that a patient reviewed the displayed 3D animation and/or 3D image stills using the computer is performed in block 43. Tracking information of the displayed 3D animation and/or 3D image stills with the computer is performed in block 44. Retrieving an informed consent form related to the displayed 3D animation and/or 3D image stills at the computer is performed in block 45. Associating the tracked information of the 3D animation and/or 3D image stills with the informed consent form at the computer is performed in block 46. Viewing the associated tracked information of the 3D animation and/or 3D image stills previously viewed and/or the information consent form is performed in block 47.

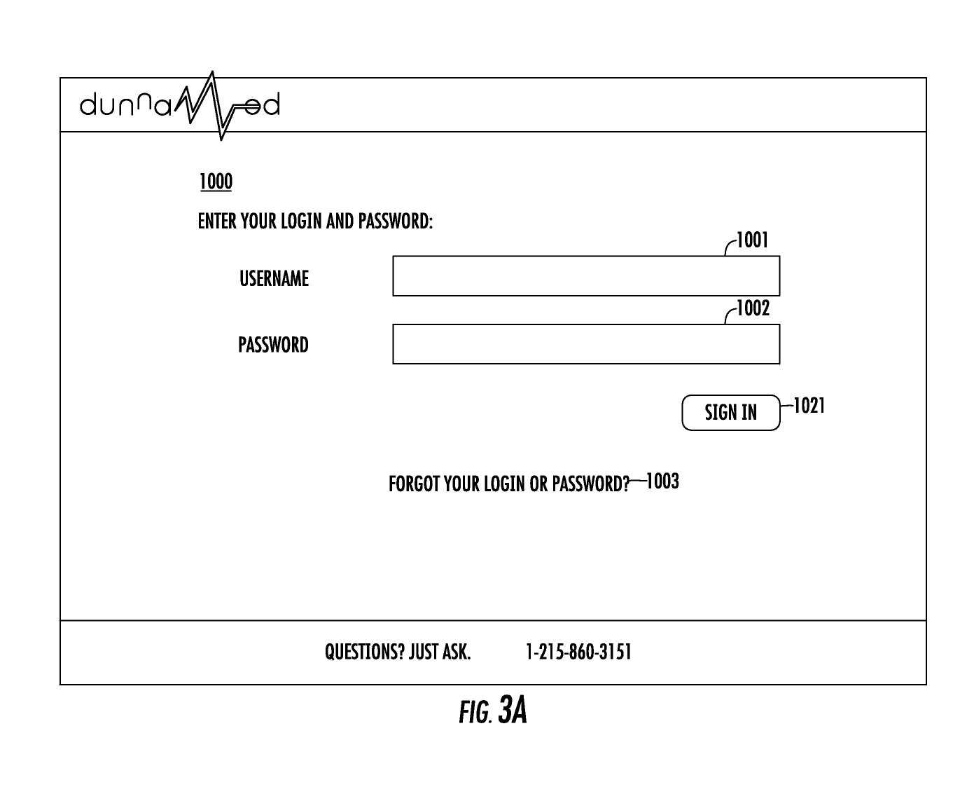

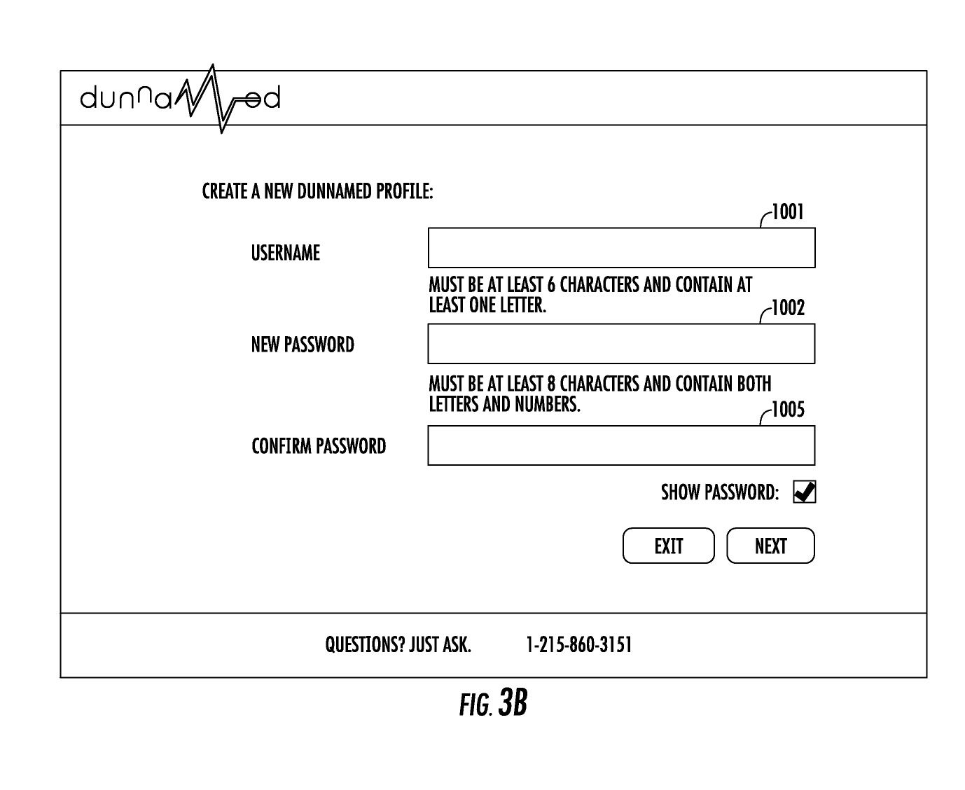

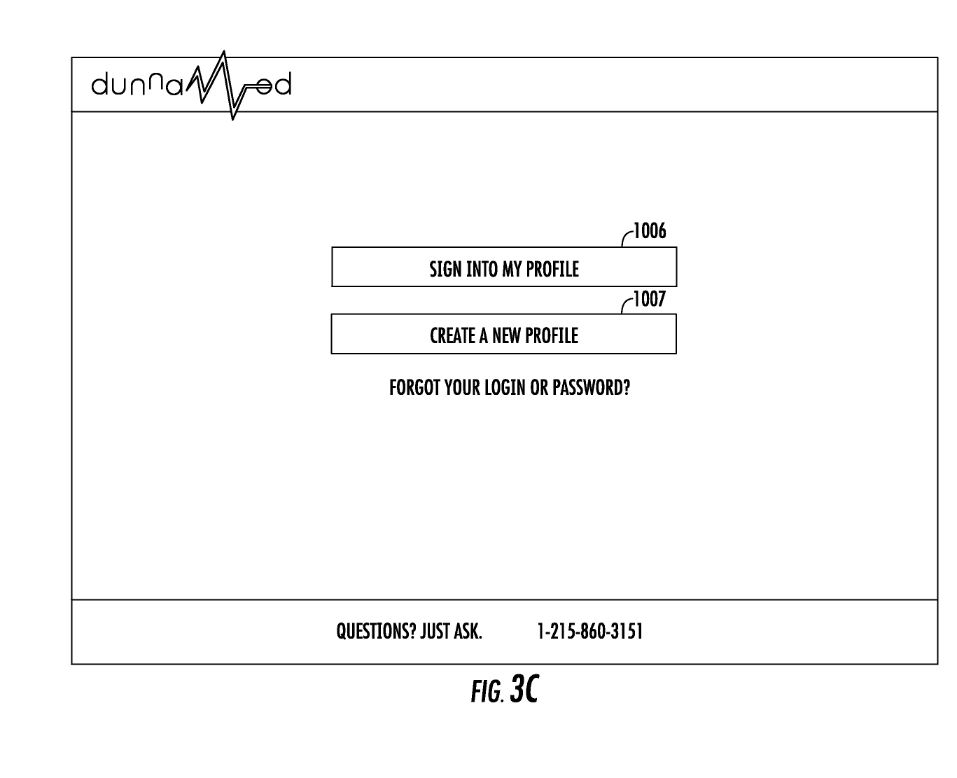

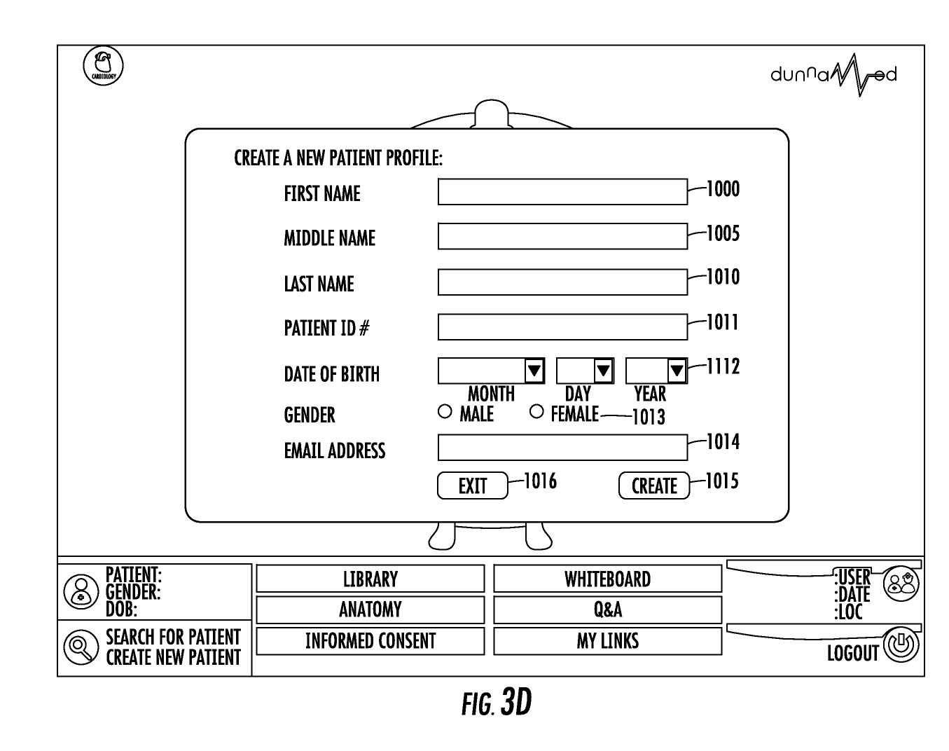

Referring to FIGS. 3A-3D, exemplary interfaces for accessing apparatus 10 are shown. In interface 1000, a user can first login by typing their username and password into blocks 1001 and 1002, respectively, to use computer program 15 as shown in FIG. 3A. If the user has a login, the user can activate button 1021 to sign into their profile.

If a user forgets their login or password, the user can click on forgot username or password in block 1003. The user will be prompted to type in their name and email address or to answer their security questions in block 1004-1005, as shown in FIG. 3B. The user can create a new password.

If the user has a login the user can sign into their profile by activating button 1006 as shown in FIG. 3C. If the user does not have a login, the user can create a new user profile by clicking on create new profile button 1007. The user can type in their first name, middle name, and last name, then register their gender, email address and select two different security questions, as well as include their answers in blocks 1008-1014 shown in FIG. 3D. Button 1015 can be activated to create the new patient profile. The user can then login to interface 1000. Button 1016 can be activated to exit creating the new patient profile.

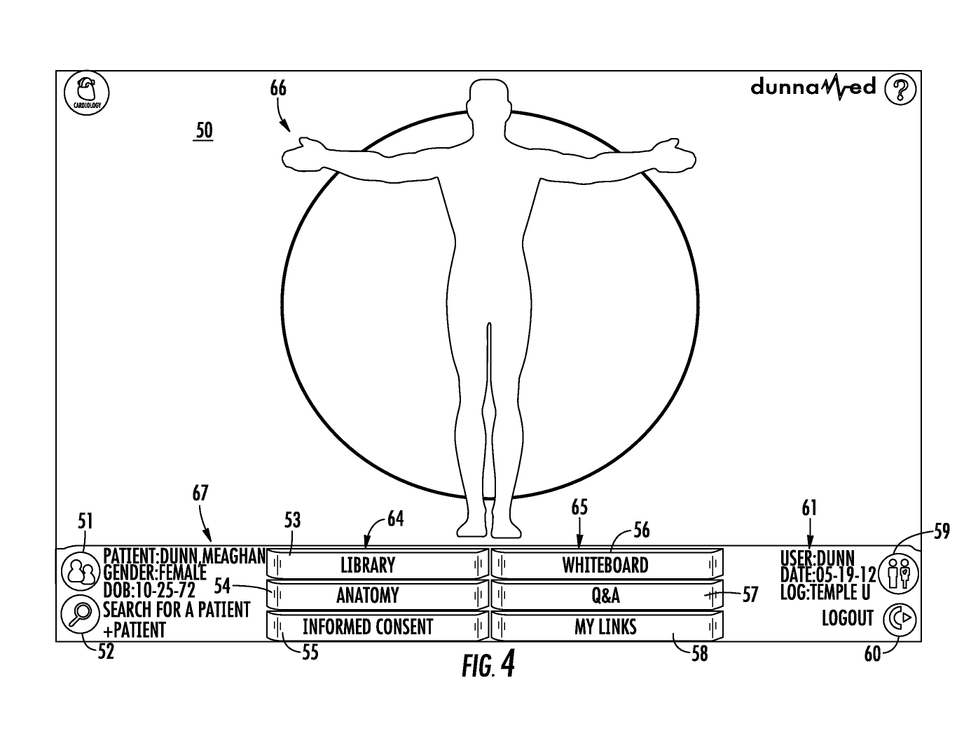

Once the user logs in, the user can be brought to main screen interface 50 as shown in FIG. 4. Main screen interface 50 can comprise buttons 51-60. On the bottom left is patient information button 51 and patient search button 52. On the bottom right is a create new patient profile button 59 and logout button 60. User information is displayed in location 61 and can be edited.

Library button 53, anatomy button 54, informed consent button 55 can be displayed on left center column of buttons 64. Whiteboard button 56, Q&A button 57 and my links button 58 can be displayed right center column of buttons 65. Display region 66 is positioned above button region 67. It will be appreciated that alternate arrangements of buttons 51-60 in button region 67 can be used in apparatus 10.

Activation of library button 53 displays a listing of 3D animation and video stills to screen 70 with 3D animation videos and images stills to choose from, as shown in

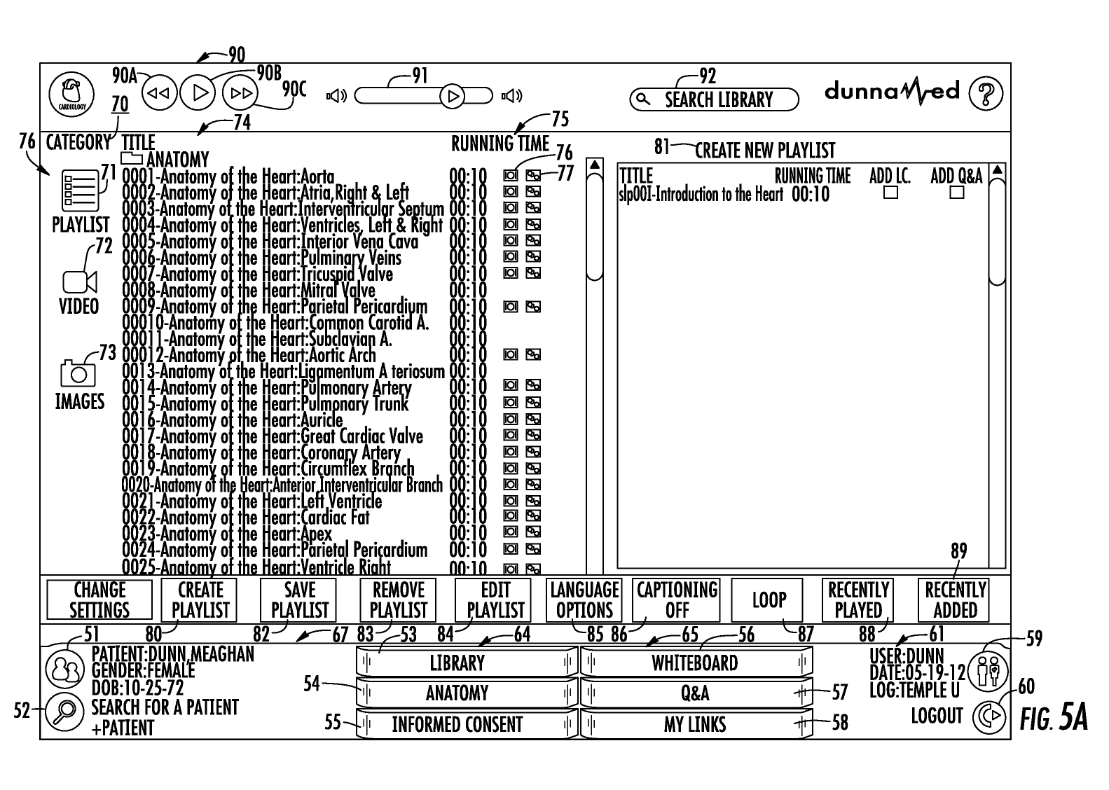

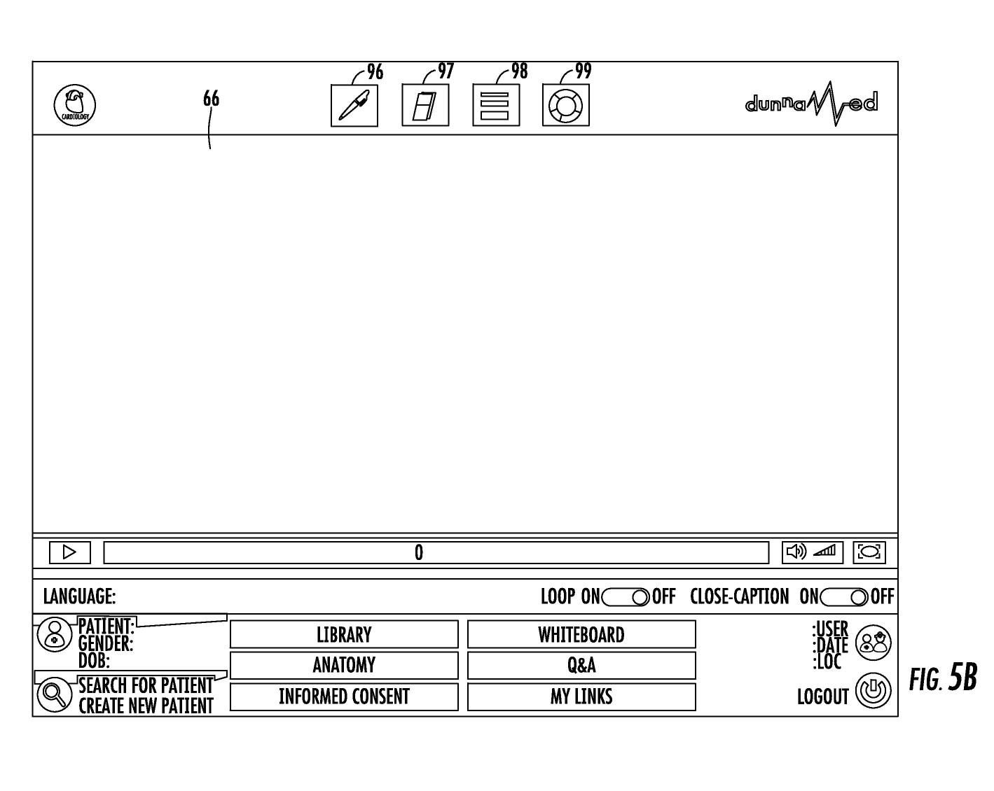

FIG. 5A. The 3D animation videos and images stills can be categorized by topic, such as, for example, anatomy, diagnosis, treatment, risk, post-op, and the like. Playlist button 71 can be activated to allow a user to choose from pre-selected 3D animation videos that have been put together as a playlist that can be used to describe the most frequently used medical stories to the patient. A playlist is displayed in area 74 and a running time associated with each item in the playlist is shown in area 75. A user can customize the playlist or create their own playlist in any order.

Create button 80 can be activated to create a playlist. Thereafter, the user can drag one or more of the displayed entries of playlist 3D animation videos from area 74 to window 81. Save playlist button 82 can be activated in order to save a new playlist under any name the user types in.

In area 75 of each entry in the playlist is an informed consent code for each of the 3D animation videos. Button 76 can be used to retrieve an informed consent for each of the 3D animation videos which are displayed. In area 75 of each entry in the playlist is a question and answer code for each of the 3D animation videos which are displayed. Question and answer button 77 can be used to retrieve a quiz of questions and answers.

Button 83 can be used to remove a playlist and button 84 can be used for editing a playlist. Button 85 can be used to select which language for the patient or captioning. Button 86 can be used for turning on and off captioning. The video can be paused at any time by touching the screen. Button 87 can be used for selecting if the video is played on a loop or expanded to a full screen. Button 88 can be activated to display recently played playlists. Button 89 can be activated to display recently added playlists.

A healthcare provider can play a single 3D animation video or playlist for the patient using buttons 90a-90c. Button 90a can be used for rewind, button 90b can be used for play and button 90c can be used for fast forward. Button 91 can be used for adjusting the volume of played voice. Button 92 can be used for searching the library for a 3D animation video for example by using keywords.

Activation of library button 53 can also display a still image library that the healthcare provider can select and show the patient. The healthcare provider can draw on this still image to help them further explain a point to the patient. The drawing on top of the still image is saved and tracked so the patient can view this later on a website the patient can access by login and password.

Informed Consent form that is a digital informed consent form supplied by the healthcare provider and is available for the patient to view digitally and sign on the tablet. The patient will receive a hard copy of the informed consent form by printing out the informed consent form with printer 29 shown in FIG. 1. Referring to FIG. 5A or 5B, informed consent button 55 can be activated to create a digital informed consent form.

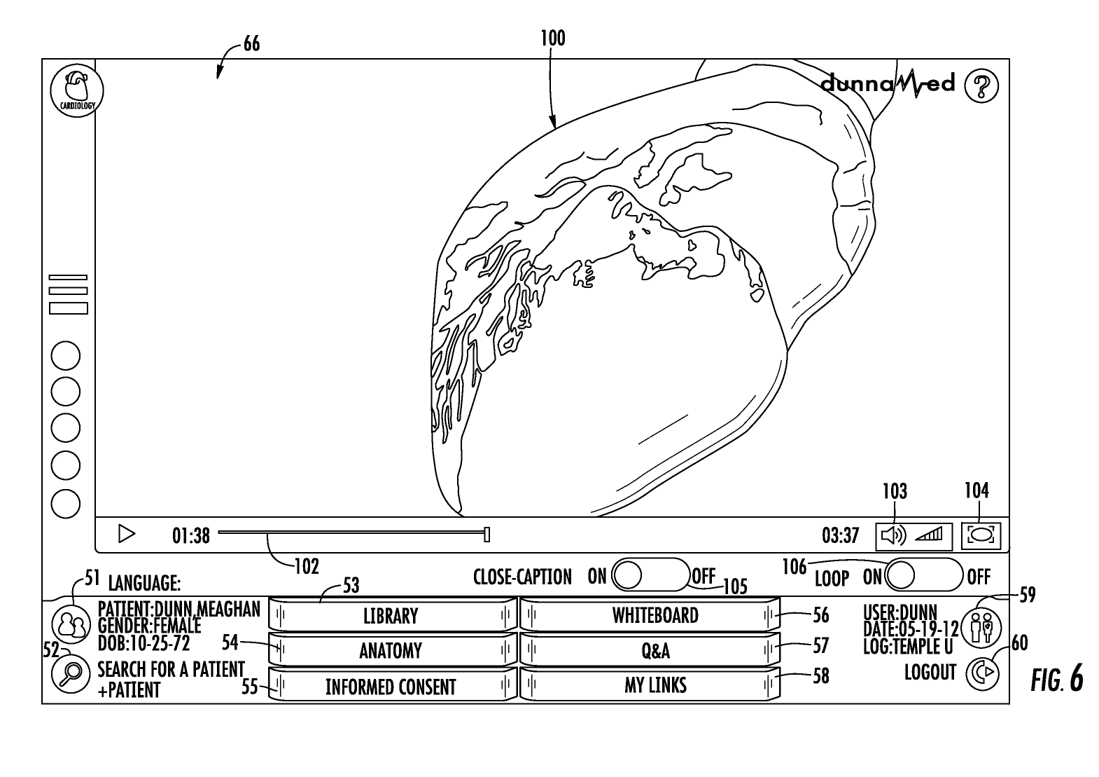

Anatomy button 54 can be activated to allow a user to select a body part/organ and examine the 3D model of it by zooming in/out on it, turning it, dissecting it into cross section views and removing layers of it. An example image of a 3D model 100 is shown in area 61 of FIG. 6. Activation of anatomy button 54 can pause the 3D animation. The user can learn about the various parts of the anatomy of the specific organ or body part in detail simply by touching it. Display area 102 indicates the run time of the 3D animation. Display area 103 indicates the speaker volume. Button 104 can be used for enlarging the 3D animation to a full screen.

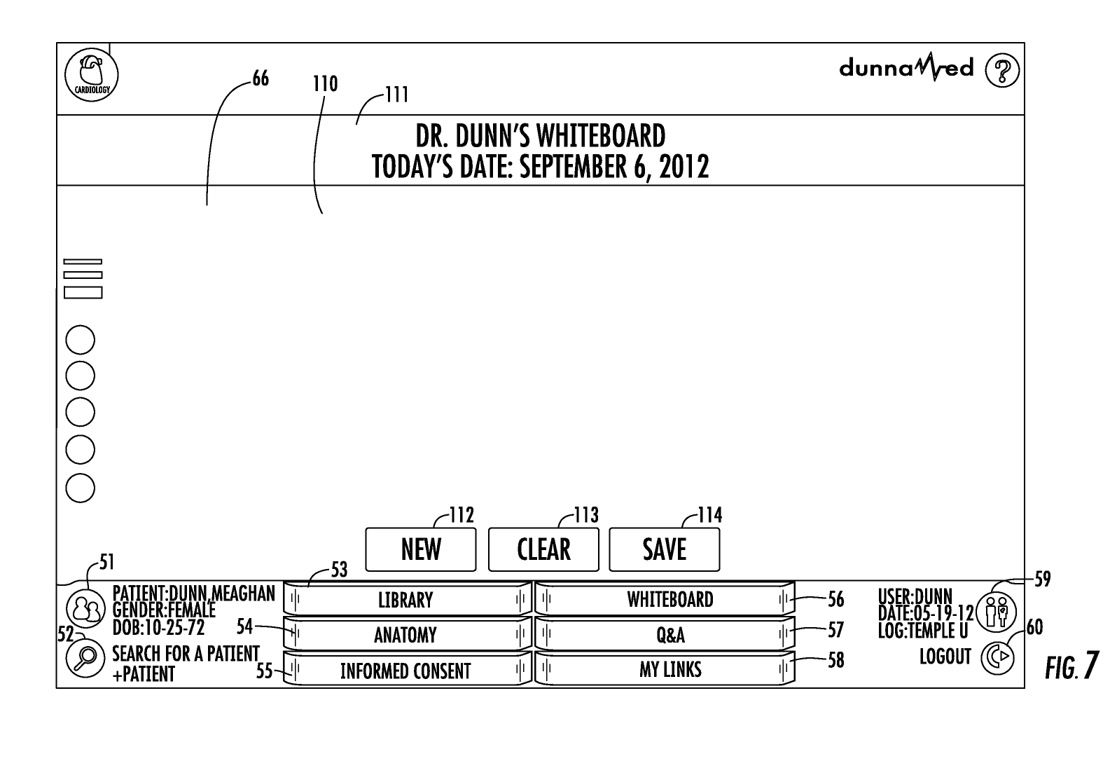

Whiteboard button 56 can be activated to allow a user to select a color and draw on a plain digital whiteboard 110 to draw out anything that may help to further explain to a patient about a specific point as shown in FIG. 7. Soft keyboard area 111 can be used so that the healthcare provider can also add notes in addition to any drawings they may have created. Button 112 can be activated to create a new whiteboard screen. Button 113 can be activated to clear the whiteboard screen. Button 114 can be activated to save the whiteboard screen.

Q&A button 57 can be activated to display an optional quiz area that can be used by the healthcare provider to walk through questions with the patient to assure that patient understands what the healthcare provider has just told them about their diagnosis or upcoming procedure. The questions given can be multiple choice questions and answers are all tracked by computer program 15.

My Links button 58 can be activated to allow a user to import their own still images into computer program 15 and similar to the whiteboard screen they will have draw options. These will also be saved for the patient to view on a website by logging in with a username and password. It will be appreciated that any of the above described buttons can be activated by clicking on the respective button with a mouse or touching a portion of a touch screen display the button.

FIG. 5B illustrates an exemplary interface displayed after button 90b is activated for playing a 3D animation video. A healthcare provider can select using button 96 a draw tool to draw on top of a paused 3D animated video. A healthcare provide can select using button 97 an eraser tool for erasing all or portions of the drawing. Button 98 can be activated for selecting thickness of the drawing tool. Button 99 can be activated for selecting a color to draw on the displayed 3D animated video. The 3D image can be saved and so the patient can later view this from a website the patient can access by login and password using website application program 32.

In an alternative embodiment, the 3D animation can be interchanged to run content in the software to cover any topic, such as automotive. Computer program 15 can run on any platform-laptop, touch screen, kiosk, pc, apple, android, smartphone, or online through a website.

During operation, a user can use computer program 15 to play the 3D animations and 3D image stills and to pause the 3D animation A user can touch the 3D still models, rotate the image, manipulate, take apart and draw on it, print out stills and play animation with various voiceover languages or close captioning that can be replayed, paused, rewound, forwarded. All usage is tracked by the seconds, minutes, hours viewed, times viewed, date viewed and then followed up with a quiz to further prove that the viewer understood what was just explained. The messaging is always consistent, eliminating the need to have an additional staff member try to explain the same message every day repeatedly throughout the day and the messaging always tracked. A website is optionally used so that the patient can also watch the exact same presentation at home to share with family members, loved ones or friends, and to review again to better educate themselves. A built in digital informed consent form with accompanying still images from the animation and/or image stills the patient just watched during the visit/exam is needed legally for the medical practice to ensure that the patient has understood what was viewed and discussed during that visit with a digital log of the date and time each animation was viewed and a quiz was taken with a score.

Embodiments of the present invention may be implemented in connection with a special purpose or general purpose computer that include both hardware and/or software components.

Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for verified education of a patient comprising the steps of:
displaying on a video display of a computer a 3D animation and/or one or more 3D image stills of a medical condition or procedure;
verifying that a patient reviewed the displayed 3D animation and/or 3D image stills using the computer;
tracking information of the displayed 3D animation and/or 3D image stills with the computer;
retrieving an informed consent form related to the displayed 3D animation and/or 3D image stills at the computer; and
associating the tracked information of the 3D animation and/or 3D image stills with the generated informed consent form at the computer.

2. The method of claim 1 wherein the 3D animation includes voiceover language or close captioning.

3. The method of claim 1 wherein the tracked information comprises one or more of seconds viewed, minutes viewed, hours viewed, times viewed, and date viewed.

4. The method of claim 1 wherein the step of verifying that a user reviewed the displayed 3D animation and/or 3D image stills comprises displaying a quiz of the displayed 3D animation and/or 3D image stills and determining from the quiz if the patient reviewed the displayed 3D animation and/or 3D image stills.

5. The method of claim 1 wherein the video display includes a touch screen and wherein the touch screen can be used touch the displayed 3D still models to rotate, manipulate, take apart and draw on the 3D image stills.

6. The method of claim 1 further comprising viewing the associated tracked information of the 3D animation and/or 3D image stills previously viewed and/or the information consent form.

7. The method of claim 1 further comprising the step of generating the 3D animation as a playlist of pre-selected 3D animation videos and/or the one or more image stills.

8. The method of claim 1 further comprising after the step of displaying the 3D animation and/or one or more image stills the step of drawing on top of the 3D animation and/or one or more image stills.

9. The method of claim 1 further comprising the step of displaying on a video display of a computer a white board and drawing on the white board for providing information about the 3D animation and/or one or more image stills.

10. An apparatus for computer-based verified education of a patient comprising;
means for displaying a 3D animation and/or 3D image stills of a medical condition or procedure;
means for verifying that a user reviewed the displayed 3D animation and/or 3D image stills;
means for tracking information of the displayed 3D animation and/or 3D image stills;
means for retrieving an informed consent form related to the displayed 3D animation and/or 3D image stills; and
means for associating the tracked information of the 3D animation and/or 3D image stills at the computer with the generated informed consent form.

11. The apparatus of claim 10 wherein the 3D animation includes voiceover language or close captioning.

12. The apparatus of claim 10 wherein the tracked information comprises one or more of seconds viewed, minutes viewed, hours viewed, times viewed, and date viewed.

13. The apparatus of claim 10 wherein means for verifying that a user reviewed the displayed 3D animation and/or 3D image stills comprises means for displaying a quiz of the displayed 3D animation and/or 3D image stills and means for determining from the quiz if the patient reviewed the displayed 3D animation and/or 3D image stills.

14. The apparatus of claim 10 wherein the video display includes a touch screen and wherein the touch screen can be used touch the displayed 3D still models to rotate, manipulate, take apart and draw on the 3D image stills.

15. The apparatus of claim 10 further comprising means for viewing the associated tracked information of the 3D animation and/or 3D image stills previously viewed and/or the information consent form.

16. The apparatus of claim 10 further comprising means for generating the 3D animation as a playlist of pre-selected 3D animation videos and/or the one or more image stills.

17. The apparatus of claim 10 further comprising means for displaying the 3D animation and/or one or more image stills drawing on top of the 3D animation and/or one or more image stills.

18. The apparatus of claim 10 further comprising means for displaying on a video display of a computer a white board and drawing on the white board for providing information about the 3D animation and/or one or more image stills.

19. A non-transitory computer readable medium storing computer program instructions for computer-based verified education of a patient, the computer program instructions defining the steps of:
displaying on a video display of a computer a 3D animation and/or 3D image stills of a medical condition or procedure;
verifying that a user reviewed the displayed 3D animation and/or 3D image stills using the computer;
tracking information of the displayed 3D animation and/or 3D image stills with the computer;
retrieving an informed consent form related to the displayed 3D animation and/or 3D image stills at the computer; and
associating the tracked information of the 3D animation and/or 3D image stills with the generated informed consent form at the computer.

20. The non-transitory computer readable medium of claim 19 wherein the 3D animation includes voiceover language or close captioning.

21. The non-transitory computer readable medium of claim 19 wherein the tracked information comprises one or more of seconds viewed, minutes viewed, hours viewed, times viewed, and date viewed.

22. The non-transitory computer readable medium of claim 19 wherein the step of verifying that a user reviewed the displayed 3D animation and/or 3D image stills comprises displaying a quiz of the displayed 3D animation and/or 3D image stills and determining from the quiz if the patient reviewed the displayed 3D animation and/or 3D image stills.

23. The non-transitory computer readable medium of claim 19 wherein the video display includes a touch screen and wherein the touch screen can be used touch the displayed 3D still models to rotate, manipulate, take apart and draw on the 3D image stills.

24. The non-transitory computer readable medium of claim 19 further comprising viewing the associated tracked information of the 3D animation and/or 3D image stills previously viewed and/or the information consent form.
